(19) United States
(12) Patent Application Publication
(10) Pub. No.: US 2003/0168561 A1
(43) Pub. Date: Sep. 11, 2003

(54) Method and appartus for holding a pacifier

(76) Inventors: Carlos E. Ortiz, Austin, TX (US); Scott B. Duff, Round Rock, TX (US)

Correspondence Address: Rick B. Yeager, 10805 Mellow Lane, Austin, TX, 78759, US

(21) Appl. No.: 10/355,386

(22) Filed: Jan. 30, 2003

Related U.S. Application Data
(60) Provisional application No. 60/352,746, filed on Jan. 30, 2002.

(51) Int. Cl. F16B 1/00

(52) U.S. Cl. 248/229.1; 248/276.1

(57) ABSTRACT

An apparatus and method for holding a pacifier in the mouth or in the proximity of the mouth of an infant while the infant is in a crib or car seat. One embodiment includes clamping an adjustable arm to the crib or car seat frame and pivoting the arm segments on hinges to a desired position. One embodiment includes a clamp to secure a flexible arm to the crib frame, and a rotatable pacifier clip which holds the rear portion of a pacifier. Other embodiments include securing the flexible arm with a plate positioned below the crib mattress; and providing one or more extension arms along an arched support arm.

### RELATED APPLICATIONS

This application is related to and claims priority from U.S. Provisional Application No. 60/352,746 filed Jan. 30, 2002 by Carlos E. Ortiz.

### FIELD OF THE INVENTION

The present invention relates to a method and apparatus for holding a pacifier in place in or near the mouth of an infant so that the infant can easily access the pacifier orally.

### BACKGROUND OF THE INVENTION

An infant often loses his pacifier and is unable to manually re-access it due to his lack of manual dexterity to pick up the pacifier from a crib mattress or a car seat. The loss of the pacifier often causes the caretaker to interrupt their sleep or driving because the infant has dropped his pacifier.

The prior art includes various ornamental devices and techniques for holding a pacifier. U.S. Pat. No. 5,607,452 issued to Michaud on Mar. 4, 1997 describes mounting a holder on a crib bar. The mounting mounts the pacifier holder to a vertical bar of a baby crib and is either a wrap around flap partly covered with Velcro™ material, or a clip-on tubular member. U.S. Pat. No. 4,994,075 issued to Smith, et al. on Feb. 19, 1991 describes an infant pacifier holder assembly sinusoidal plastic cord and a clip member which can be clipped to the clothes of an infant. U.S. Pat. No. 4,700,408 issued to Winger on Oct. 20, 1987 describes a Y-shape pacifier holder where the upper arms have Velcro™ hook and pile sections or other suitable fasteners at their distal ends to permit them to be attached to each other behind the infant's neck to position the holder around the infant's neck with the base leg of the Y-shape hanging in front of the infant, on his or her chest. U.S. Pat. No. 4,972,980 issued to Parsons on Nov. 27, 1990 describes a pacifier holder with an ornamental member having an ornamental front surface with integral snap lock means connected with the rear surface thereof, and a snap ring removably connected with the snap lock assembly of the ornamental member, whereby when a piece of fabric such as an article of infant clothing is arranged between the ornamental member and the snap ring, the ornamental member is connected with the fabric. U.S. Pat. No. 6,269,502 issued to Exstrom on Aug. 7, 2001 describes a method and apparatus combining pacifier, pacifier holder and swaddling blanket for extended pacification of infants. U.S. Pat. No. 5,593,336 issued to Thomas on Jan. 14, 1997 describes a pacifier holder with a soft lightweight elongated generally tubular member that is placed upon the infant's chest. U.S. Pat. No. D300,281 issued to Coates on Mar. 21, 1989 describes a combination bib with pacifier holder.

### SUMMARY OF THE INVENTION

The current invention provides a method for holding a pacifier in place in or near the mouth so that an infant can easily access it orally. In one embodiment, a clamp mechanism is used which allows the device to adjustably clasp to a crib frame such as a slat, or to a car seat frame such as a handle or side. In this embodiment, the clamp is affixed to an adjustable and flexible arm which stretches to the required distance to place the pacifier in the infant's mouth. In this embodiment, the end of the adjustable arm has a clip which adjusts and clasps the infant's pacifier. This clasp is fully adjustable as to the angle in which the pacifier is presented to the infant. The infant and the pacifier holder with the pacifier in place are adjusted so that the infant's pacifier is in or near her mouth.

The invention allows the infant to yawn, cry or open his mouth without the pacifier falling to a place where the infant can not retrieve it without assistance.

### BRIEF DESCRIPTION OF THE DRAWINGS

FIG. 1A is a side view of a crib pacifier holder with adjustable arm.

FIG. 2A is a side view of a car seat pacifier holder with adjustable arm.

FIG. 3A is a side view of a plate-mounted flexible arm embodiment of a crib pacifier holder.

FIG. 3B is a side view of a clasp-mounted flexible arm embodiment of a crib pacifier holder.

FIG. 4A is a side view of an arched crib pacifier holder.

FIG. 4B is a side view of an adjustable extension arm for the arched crib pacifier holder of FIG. 4A.

### DETAILED DESCRIPTION OF EMBODIMENT

Clasp-mounted Adjustable Arm for Crib

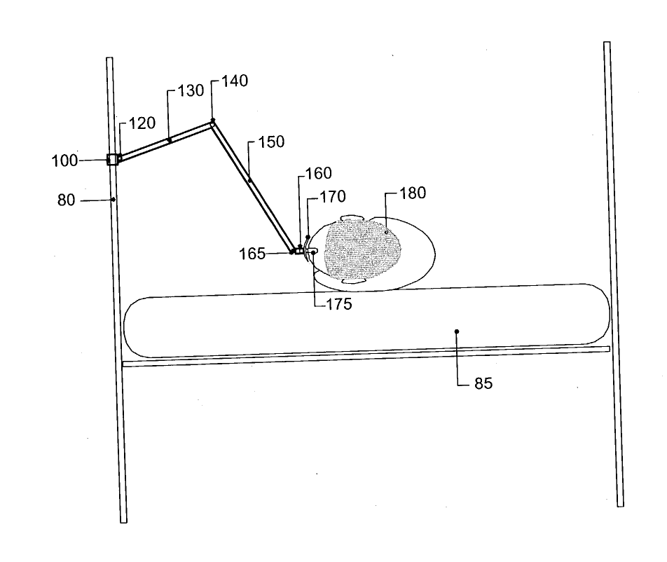

Referring to FIG. 1, which is a side view of a crib pacifier holder with adjustable arm, the clasp 100 or clamp mechanism typically clamps to a crib frame member such as a side rail 80 or slat. The clasp is typically a spring clip which may be opened slightly larger than the crib frame member and then released to clamp onto the crib frame member. A crib is defined as a bassinet for small infants as well as a conventional small child's bedstead with high enclosing, usually, slatted sides. In one embodiment, the clasp includes a first hinge 120 attached to a first adjustable arm segment 130 so that the first arm segment can pivot with respect to the first hinge. In this embodiment, a second hinge 140 connects the first arm segment 130 to a second arm segment 150 and permits the second arm segment to pivot with respect to the first arm segment. A pacifier clip 160 is secured to the end of the second arm segment in a manner that permits the pacifier clip to rotate. This rotation may be provided by a ball joint 165 in the pacifier clip or between the pacifier clip and the second arm segment. A pacifier 170 is placed within the pacifier clip so that the front of the pacifier 170 is presented towards the infant 180 and the infant's mouth 175. In an alternate embodiment, the pacifier clip is in a fixed position relative to the end of the second arm segment. In an alternate embodiment, the pacifier clip is in a fixed position relative to the end of the second arm segment, and the pacifier may be inserted into the pacifier clip at a desired angle. The combination of the first hinge and the second hinge permits the adjustable arm segments to be positioned so that the pacifier clip may be positioned at a desired location within the crib. Typically, this desired location is such that the pacifier is either in the infant's mouth or held very near the infant's mouth. This location is typically 1-3 inches above the crib mattress. When the pacifier clip is positioned in this manner, the pacifier remains near the infant's mouth and the infant can retrieve the pacifier. For instance, if the child yawns, then the pacifier might normally be dropped, but with this invention, the pacifier is held close so that the pacifier is either gently nudged back toward the mouth, or held in the proximity of the mouth so that the child can find and recover it. The pacifier is maintained relatively clean by keeping it off the surface of the crib. In one embodiment, the clamp and adjustable arms are provided of an injection molded plastic material, and includes a first arm segment of about eight inches in length and a second arm segment of about eight inches in length. The device may have other dimensions or materials.

One method of using the device is to provide the device, which includes the clamp mechanism, a first hinge mechanism, a first arm segment, a second hinge mechanism, a second arm segment and a pacifier clip; to attach the clamp mechanism to the frame of the crib; to place a pacifier in the pacifier clip; to pivot the first arm segment with respect to the clamp; and then to pivot the second arm segment with respect to the first arm segment so that the pacifier is placed in or near the mouth of an infant in the crib. The hinge mechanisms are provided with a moderate resistance so that they can be adjusted easily by hand but stay is a set position until adjusted. Alternately, the hinge mechanisms may include a tightening device such as a wing nut to lock a desired position.

Clasp-mounted Adjustable Arm for Car Seat

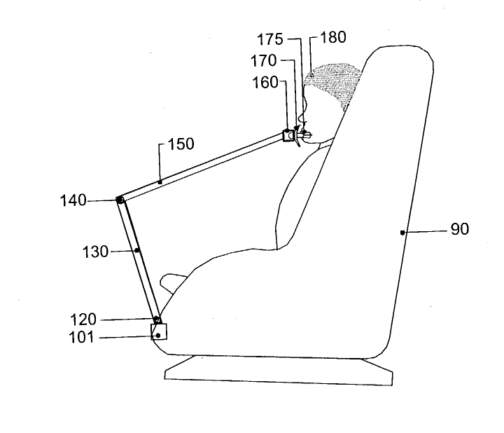

Referring to FIG. 2, which is a side view of a car seat pacifier holder with adjustable arm, the clasp 101 typically clamps to the frame of the car seat such as the side of the car seat 90 or the restraint bar. The clasp is typically a spring clip which may be opened slightly larger than the car seat frame and then released to clamp onto the car seat frame member. In one embodiment, the clasp has a first hinge 120 attached to a first adjustable arm segment 130 so that the first arm segment can pivot with respect to the first hinge. In this embodiment, a second hinge 140 connects the first arm segment 130 to a second arm segment 150 and permits the second arm segment to pivot with respect to the first arm segment. A pacifier clip 160 is secured to the end of the second arm segment in a manner that permits the pacifier clip to rotate. This rotation may be provided by a ball joint 165 in the pacifier clip or between the pacifier clip and the second arm segment. A pacifier 170 is placed within the pacifier clip so that the front of the pacifier 170 is presented towards the infant's mouth 175. The combination of the first hinge and the second hinge permits the adjustable arm segments to be positioned so that the pacifier clip may be positioned at a desired location relative to the position of the infant's head when the infant is in the carseat. Typically, this desired location is such that the pacifier is either in the infant's mouth or held very near the infant's mouth. When the pacifier clip is positioned in this manner, the pacifier remains near the infant's mouth and the infant can retrieve the pacifier. The pacifier is maintained relatively clean by keeping it off the surface of the carseat, the automobile seat, or the automobile floorboard. In one embodiment, the clamp and adjustable arms are provided of an injection molded plastic material, and includes a first arm segment of about eight inches in length and a second arm segment of about eight inches in length. In one embodiment, a single mechanism may be used on both a crib and a carseat, and the device may be moved as desired.

Plate-mounted Flexible Arm for Crib

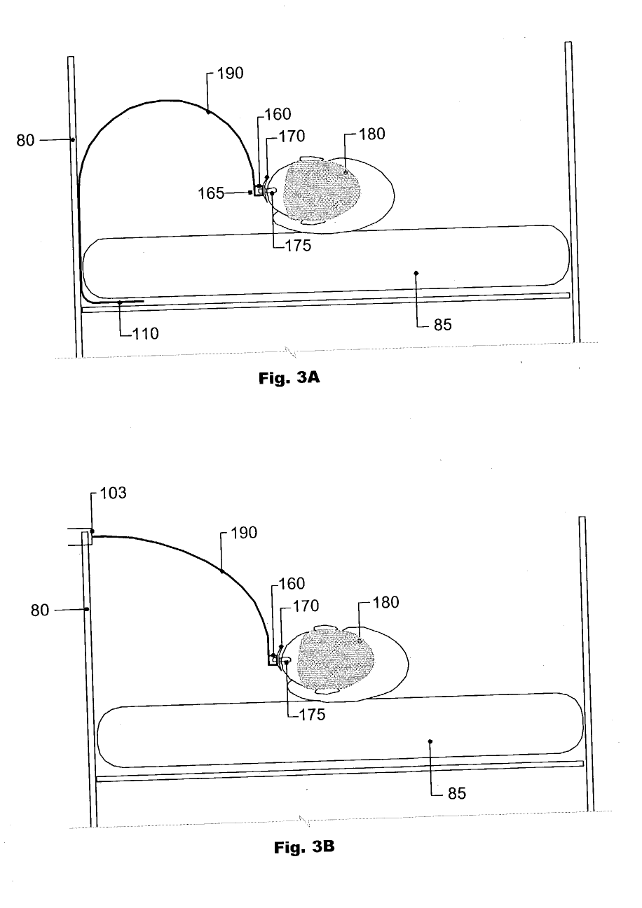

Referring to FIG. 3A, which is a side view of a plate-mounted flexible arm pacifier holder, a plate 110 typically is positioned below a portion of the crib mattress 85 so that the weight of the mattress holds the plate in position. One end of a flexible arm 190 is affixed to the plate. The flexible arm may be segmented, or may be provided as a stiff wire. The flexible arm may have a safety or decorative cover. The pacifier clip is held at a desired location by bending the flexible arm in one or more locations so that the pacifier clip is provided in the desired location.

One method of using the device is to provide the device, which includes the plate, a flexible arm member, and a pacifier clip; to position the plate below a crib mattress; to place a pacifier in the pacifier clip; and then to bend the flexible arm member so that the pacifier is placed in or near the mouth of an infant in the crib.

Clasp-Mounted Flexible Arm

Referring to FIG. 3B, which is a side view of a clasp-mounted flexible arm pacifier holder, a clasp 103 is affixed to the crib frame or car seat frame. The flexible arm 190 may be segmented or may be provided as a stiff wire with a safety or decorative cover. In this embodiment, the pacifier clip 160 is held at a desired location by bending the flexible arm 190 in one or more locations so that the pacifier clip is provided in the desired location.

One method of using the device is to provide the device, which includes the clamp mechanism, a flexible arm member, and a pacifier clip; to attach the clamp mechanism to the frame of the crib or carseat; to place a pacifier in the pacifier clip; and then to bend the flexible arm member so that the pacifier is placed in or near the mouth of an infant in the crib or carseat.

Arched Arm for Crib

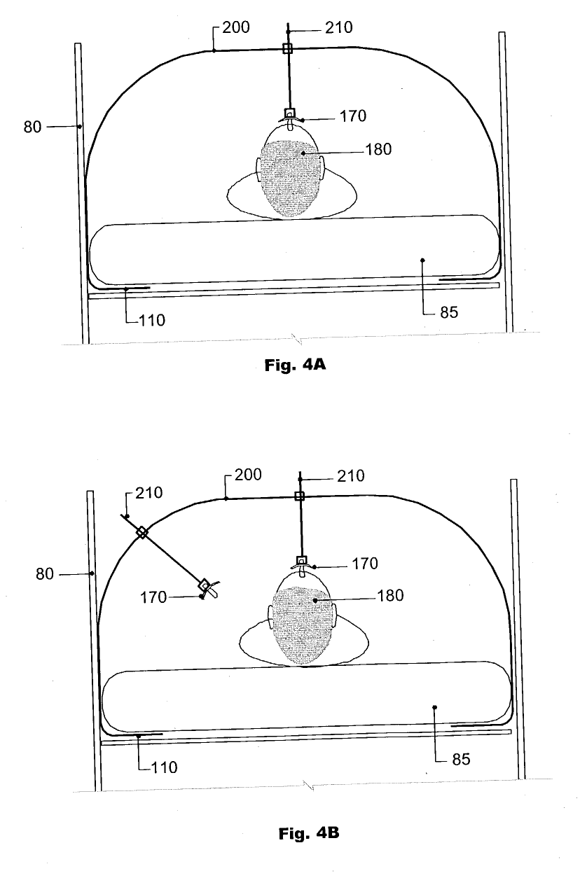

Referring to FIG. 4A, which is a side view of an arched arm crib pacifier holder, an arched member 200 is supported above the crib mattress 85. In one embodiment, the arched member is a flexible arm such as a segment or stiff wire which is formed in an arch over the crib mattress. In one embodiment, the arched arm has a plate on each end so that both plates may be placed under the mattress. In another embodiment, the arched arm is supported by clasps on the crib frame. The term arched arm refers to a support arm where at least a portion of the arm is elevated above the crib, and the support arm has different heights above the crib at various positions. Near its ends, the arched arm is essentially vertical so that an extension arm can be provided sideways toward the infant's mouth. Near the middle of the arched arm, the arm is essentially horizontal so that an extension arm can be provided downward toward the mouth on an infant positioned on its back.

Referring now to FIG. 4B, which is a side view of an adjustable extension arm for the arched crib pacifier holder of FIG. 4A, one or more adjustable extension arms 210 is mounted on the arched member 200 so that the adjustable extension arm may be placed where one end is in proximity to the mouth of an infant. In this embodiment, the length of the adjustable extension arm may be changed.

What is claimed is:

1. A device for holding a pacifier in proximity to the mouth of an infant in a crib, the device comprising
a pacifier clip, such that a pacifier may be placed in the clip in a manner that presents the front of the pacifier to the infant;
an arm anchoring mechanism;
an adjustable arm connecting the pacifier clip to the arm anchoring mechanism, such that the arm may be adjusted in order to position the pacifier clip within the crib.

2. The device of claim 1 wherein the arm anchoring mechanism is a clamp affixed to the frame of the crib.

3. The device of claim 1 wherein the arm anchoring mechanism is an anchor plate, such that the plate may be placed under a portion of a mattress in the crib.

4. The device of claim 1 wherein the pacifier clip is rotatable in three planes such as with a ball joint mechanism.

5. The device of claim 1 further comprising
at least two hinges in the adjustable arm between the arm anchoring mechanism and the pacifier so as to permit changing the distance between the crib frame and the pacifier clip.

6. The device of claim 1 wherein the adjustable arm is a compliant arm member, such as a flexible rod, and the pacifier clip can be positioned by bending the adjustable arm.

7. A device for holding a pacifier in proximity to the mouth of an infant in a crib, the device comprising
a pacifier clip, such that a pacifier may be placed in the clip in a manner that presents the front of the pacifier to the infant;
a clamp affixed to the frame of the crib;
an adjustable arm mechanism comprising
a first arm segment, having a first end and a second end,
a first pivot mechanism positioned between the clamp and the first end of the first arm segment, such that the first arm segment may be pivoted with respect to the clamp,
a second arm segment, having a first end and a second end, such that the pacifier clip is affixed to the second end,
a second pivot mechanism positioned between the second end of the first arm segment and the first end of the second arm segment, such that the second arm segment may be pivoted with respect to the first arm segment, thereby permitting the pacifier clip to be positioned at a desired location within the crib.

8. A device for holding a pacifier in proximity to the mouth of an infant in a crib, the device comprising
a pacifier clip, such that a pacifier may be placed in the clip in a manner that presents the front of the pacifier to the infant;
an anchor plate, such that the plate may be placed under a portion of a mattress in the crib;
a compliant arm member, having a first end connected to the anchor plate, and having a second end connected to the pacifier clip, such that the compliant arm member may be bent into a desired shape in order to position the pacifier clip at a desired location within the crib.

9. A device for holding a pacifier in proximity to the mouth of an infant in a car seat, the device comprising
a pacifier clip, such that a pacifier may be placed in the clip in a manner that presents the front of the pacifier to the infant;
an arm anchoring mechanism;
an adjustable arm connecting the pacifier clip to the arm anchoring mechanism, such that the arm may be adjusted in order to position the pacifier clip within the crib.

10. The device of claim 9 wherein the arm anchoring mechanism is a clamp affixed to the frame of the car seat.

11. The device of claim 9 wherein the pacifier clip is rotatable in three planes such as with a ball joint mechanism.

12. The device of claim 9 further comprising at least two hinges in the adjustable arm between the arm anchoring mechanism and the pacifier so as to permit changing the distance between the car seat frame and the pacifier clip.

13. The device of claim 9 wherein the adjustable arm is a compliant arm member, such as a flexible rod, and the pacifier clip can be positioned by bending the adjustable arm.

14. A device for holding a pacifier in proximity to the mouth of an infant in a crib, the device comprising
a pacifier clip, such that a pacifier may be placed in the clip in a manner that presents the front of the pacifier to the infant;
an arched member anchoring mechanism;
an arched member supported above a mattress in the crib by the arched member anchoring mechanism; and
at least one extension arm supported by the arched member, such that the pacifier clip is secured to one end of the extension arm, and such that the extension arm length may be adjusted in order to position the pacifier clip within the crib.

15. The device of claim 14 wherein the pacifier clip is rotatable in three planes such as with a ball joint mechanism.

16. The device of claim 14 wherein the arched member anchoring mechanism comprises
a first anchor plate attached to a first end of the arched member; and
a second anchor plate attached to a second end of the arched member, such that the first anchor plate and the second anchor plate are positioned under a mattress placed in the crib.

17. A method for holding a pacifier in proximity to the mouth of an infant while in a baby crib, the method comprising
clamping an adjustable arm to the frame of the crib;
positioning a pacifier clip on the adjustable arm, such that the pacifier clip may hold a pacifier;
placing a pacifier in the pacifier clip; and
adjusting the adjustable arm such that the pacifier is in proximity to the mouth of the infant.

18. The method of claim 17 wherein adjusting the adjustable arm such that the pacifier is in proximity to the mouth of the infant is accomplished by
providing the adjustable arm as a flexible member; and
bending a flexible member into a shape so that the end of the flexible member is in a desired location.

19. The method of claim 17 wherein adjusting the adjustable arm such that the pacifier is in proximity to the mouth of the infant is accomplished by
pivoting a first arm segment in a first hinge; and
pivoting a second arm segment in a second hinge so that the end of the adjustable arm member is in a desired location.

20. A method for holding a pacifier in proximity to the mouth of an infant while in a baby crib, the method comprising
securing a flexible arm relative to the frame of the crib;
positioning a pacifier clip on the flexible arm, such that the pacifier clip may hold a pacifier;
placing a pacifier in the pacifier clip; and
bending the flexible member into a shape so that the pacifier is in a desired location in proximity to the mouth of the infant.

21. A method for holding a pacifier in proximity to the mouth of an infant while in a car seat, the method comprising
clamping an adjustable arm to the frame of the carseat;
positioning a pacifier clip on the adjustable arm, such that the pacifier clip may hold a pacifier;
placing a pacifier in the pacifier clip; and
adjusting the adjustable arm such that the pacifier is in proximity to the mouth of the infant.

22. The method of claim 21 wherein adjusting the adjustable arm such that the pacifier is in proximity to the mouth of the infant is accomplished by
pivoting a first arm segment in a first hinge; and
pivoting a second arm segment in a second hinge so that the end of the adjustable arm member is in a desired location.
